(19) United States
(12) Patent Application Publication
(10) Pub. No.: US 2005/0047158 A1
(43) Pub. Date: Mar. 3, 2005

(54) Combination indicator and blind spot mirror

(76) Inventor: Karsten Koehler, Barrington Hills, IL (US)

Correspondence Address: BRINKS HOFER GILSON & LIONE, P.O. BOX 10395, CHICAGO, IL, 60610, US

(21) Appl. No.: 10/652,887

(22) Filed: Aug. 29, 2003

(51) Int. Cl. B60Q 1/00

(52) U.S. Cl. 362/487

(57) ABSTRACT

A combination indicator and blind spot mirror having a housing, the housing including a base capable of being secured to a mirror. A mirror glass is secured to the housing. At least one light is included that is operative in relation to an automotive event.

### BACKGROUND OF THE INVENTION

Blind spot mirrors are used to indicate the presence of a car or other object in the “blind spot” of a driver of an automotive device. One type of blind spot is formed by the configuration of standard side view and rear view mirrors in relation to the body of a car. For example, two blind spots may be formed by the rear supports of the roof of the car, such that a driver is unable to see the area behind the supports in the rear view mirror. And, the side view mirrors of the car may be angled such that the driver does not have a view of objects immediately next to or behind the car in the area behind the rear supports.

Blind spot mirrors may also be used in many other situations to allow a driver to see objects more clearly or easily than by using his standard line of vision and his standard mirrors. For example, a tractor-trailer driver, without access to a rear view mirror, may have only a standard truck side view mirror to see objects around his tractor-trailer. He may use a blind spot mirror mounted to his side view mirror in order to increase his field of vision.

Some automotive side view mirrors include turn signal indicators in order to better notify other drivers of an intent to change lanes or turn. These indicators may also be visible to the drivers of the automotive devices to which they are affixed and remind the driver that a turn signal has been activated in case it needs to be manually shut off later.

These turn signal indicators have been integrated into automotive side view mirrors in a variety of ways—some examples of this may be found in U.S. Pat. No. 6,264,353 to Caraher et al.; U.S. Pat. No. 5,059,015 to Tran; and U.S. Pat. No. 5,402,103 to Tashiro. These patents, in their entirety, are incorporated herein by reference.

Concerns about the automotive side view mirrors that include turn signal indicators may include their cost of manufacture and difficulty of aftermarket installation. Further, these mirrors may lack multicolor or variously sized lights to indicate different automotive events, and these mirrors may not provide indication of certain automotive events. As well, the size and shape of the mirrors may be predetermined by the design of the car, as opposed to being selectable by the consumer. Finally, such mirrors may not provide blind spot mirror functionality.

A combination indicator and blind spot mirror is needed that addresses at least some of the limitations of the prior art.

### BRIEF SUMMARY OF THE INVENTION

One aspect of the present invention provides a combination indicator and blind spot mirror with a housing having a base capable of being secured to an automotive side view mirror. A mirror glass is secured to the housing. At least one light extends at least partially exterior of the housing. The at least one light is operative in relation to an automotive event.

Another aspect of the invention provides a combination indicator and blind spot mirror with a housing, at least a portion of which is translucent. The housing has a base capable of being secured to an automotive side view mirror, and a mirror glass is secured to the housing. The translucent portion of the housing is illuminated by at least one light in relation to an automotive event.

Yet another aspect of the invention provides a combination indicator and blind spot mirror with a mirror glass having a non-reflective portion adjacent to an edge of the mirror glass. The mirror glass is secured to a housing, which has a base capable of being secured to a mirror. Light emitted from at least one light shines through the non-reflective portion of the mirror glass in relation to an automotive event.

### BRIEF DESCRIPTION OF SEVERAL VIEWS OF THE DRAWINGS

FIG. 1 is a perspective view of a combination indicator and blind spot mirror and an automotive side view mirror assembly.

FIG. 2 is a cross-section view of the combination indicator and blind spot mirror taken along line 2-2 of FIG. 1.

FIG. 3 is an exploded view of a portion of the combination indicator and blind spot mirror of FIG. 1.

FIG. 4 is a perspective view of a second embodiment having a rounded housing combination indicator and blind spot mirror, with differently-sized lights.

FIG. 5 is a perspective view of a third embodiment having a rectangular housing combination indicator and blind spot mirror, with lights extending from the housing.

FIG. 6 is a perspective view of a fourth embodiment having a rounded housing combination indicator and blind spot mirror, with lights inside a protective enclosure.

FIG. 7 is a perspective view of a fifth embodiment having a rounded housing combination indicator and blind spot mirror, with lights arranged in a semicircle inside a protective enclosure.

FIG. 8 is a perspective view of a sixth embodiment having a rounded housing combination indicator and blind spot mirror, with lights arranged in a circle inside a protective enclosure.

FIG. 9 is a perspective view of a seventh embodiment having a rounded housing combination indicator and blind spot mirror, with lights in a side of the rounded housing.

FIG. 10 is a perspective view of an eighth embodiment having a combination indicator and blind spot mirror, with a mirror glass having a non-reflective portion adjacent to an edge of the mirror glass.

FIG. 11 is a cross-section view of the combination indicator and blind spot mirror taken along line 11-11 of FIG. 10.

FIG. 12 is a perspective view of a ninth embodiment having a combination indicator and blind spot mirror with a housing, at least a portion of which is translucent.

FIG. 13 is a cross-section view of the combination indicator and blind spot mirror taken along line 13-13 of FIG. 12.

### DETAILED DESCRIPTION OF THE DRAWINGS AND PREFERRED EMBODIMENTS OF THE INVENTION

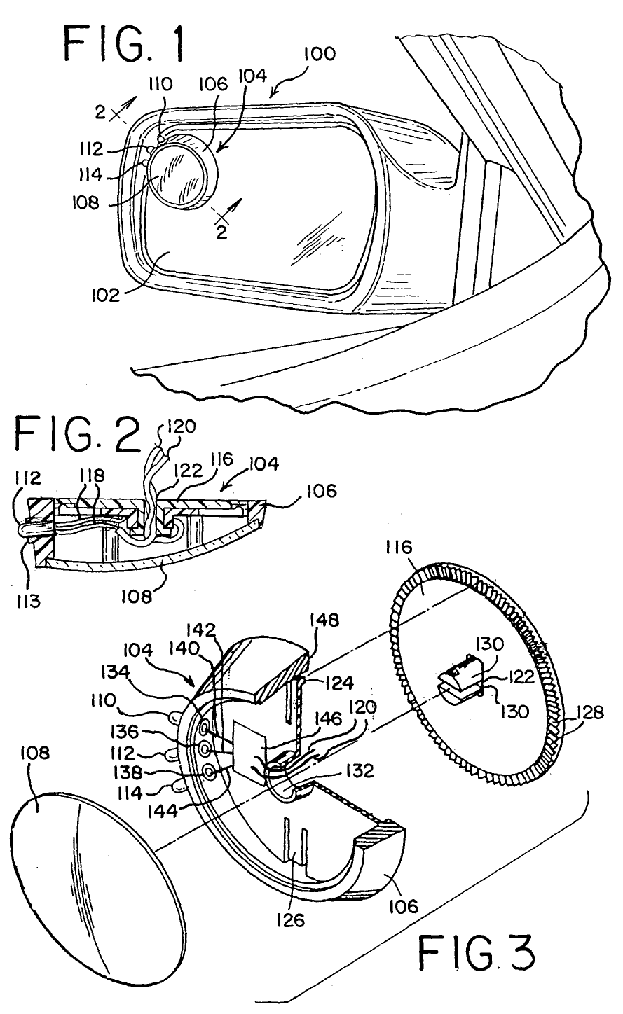

FIG. 1, discloses an automotive side view mirror assembly 100 having a side view mirror 102. The automotive side view mirror assembly 100 may be, for example, a side view mirror assembly for a car, truck, bus, motorcycle, scooter, boat, farm implement, or piece of construction equipment. An exemplary, preferred combination indicator and blind spot mirror 104 (also shown in FIGS. 2 and 3) is secured to the side view mirror 102. The combination indicator and blind spot mirror 104 has a housing 106 with a mirror glass 108 secured to the housing 106. Preferably, the housing 106 is made of plastic, and the mirror glass 108 is a convex mirror glass suitable for use as a blind spot mirror. The housing 106 may be rounded, rectangular, or some other shape. The housing 106 also has a base 116 (FIG. 3) which is capable of being secured to the side view mirror 102, preferably by an adhesive backing. Three lights 110, 112, 114 extend from the housing 106 of the combination indicator and blind spot mirror 104.

These lights 110, 112, 114 are preferably light-emitting diodes (“LEDs”) and may be of varying sizes and colors: for example, they may be red, white, blue, or yellow lights. The lights 110, 112, 114 are preferably operative in relation to an automotive event. Notification of the automotive event may be received by the combination indicator and blind spot mirror 104 in a variety of ways—for example, the notification may be received wirelessly, as by a radio frequency signal, or over a wire. The automotive event may include a turn signal actuation, a hazard signal actuation, a brake actuation, a reverse direction actuation, or other automotive event. These actuations may be, for example, in response to a driver action to actuate a control within the automotive device. For instance, moving a turn signal lever may be a turn signal actuation; pressing a hazard light button may be a hazard signal actuation; pressing a brake pedal may be a brake actuation; or, shifting into reverse may be a reverse direction actuation. Further, the automotive event may include a key accessory actuation, locking mechanism actuation, a door actuation, a motion actuation, an alarm actuation, or other automotive event. For example, pressing a button on or speaking into a key or key chain may be a key accessory actuation; locking or unlocking a door may be a locking mechanism actuation; opening or closing a door may be a door actuation; sensing of motion by a motion detector may be a motion actuation; or, the triggering of a car alarm may be an alarm actuation. The automotive event may also be a headlight actuation, parking light actuation, or other automotive event. For example, turning a headlight control knob to a headlight setting may be a headlight actuation; or, turning the headlight control knob to a parking light setting or moving a light lever to a parking light setting may be a parking light actuation.

The lights 110, 112, 114 may be operative in a variety of ways to different automotive events. For example, some or all of the lights 110, 112, 114 may be operative in relation to a particular automotive event, or the lights 110, 112, 114 may be alternately operative in relation to a particular automotive event such that one light 110 may illuminate followed by another light 112. The lights 110, 112, 114 may also be operative in different colors in relation to a particular automotive event. For example, one light 110 may illuminate yellow for a hazard signal actuation and red for a brake actuation.

FIG. 2 is a cross-section view of the exemplary combination indicator and blind spot mirror 104 including a base 116. The mirror glass 108 is convex and may be suitable for use as a blind spot mirror. The light 112, connected to electrical wires 118, extends through an aperture 113 in the housing 106.

FIG. 3 shows an exploded view of the exemplary combination indicator and blind spot mirror 104. The housing has two tabs 124, 126 that engage a plurality of teeth 128 arranged around the base 116. In this embodiment, the base 116 is connected to the housing 106 by expanding stubs 130 that fit inside a receiving aperture 132 in the housing 106. The stubs 130 are adjacent to a base aperture 122. Here, the base 116 is attached to but separate of the remainder of the housing 106, with the base 116 and remainder of the housing 106 further being rotatably attached. In this way, when the base 116 is secured to a side view mirror, the remainder of the housing 106 may be rotated. Normally, the tabs 124, 126 are biased so as to engage the teeth 128 to hold the position of the remainder of the housing relative to the base. However, when rotating force is applied to the remainder of the housing 106—for example, by the hand of a driver—the bias of the tabs 124, 126 is overcome to allow rotation of the remainder of the housing 106. In effect, this causes the tabs 124, 126 to quickly engage and disengage the teeth 128 on the base 116, as the housing 106 rotates. Even so, the housing 106 is not required to have a rotatable base 116. For example, the remainder of the housing 106 may be secured by a base formed by the bottom edge 148 of the housing 106 or any other type of base.

Further, each of the three lights 110, 112, 114 extending exterior of the housing has a respective wire connection terminal 134, 136, 138. At the wire connection terminals 134, 136, 138, the lights 110, 112, 114 are connected to electrical wires 140, 142, 144. The electrical wires 140, 142, 144 optionally connect to control circuitry 146. Optionally, the control circuitry 146 may receive notice of automotive events, direct the operation of the lights 110, 112, 114, and route power to the lights 110, 112, 114. As shown here, wires 120 extend from the control circuitry 146, through receiving aperture 132 and base aperture 122 to a power source (not shown). The power source may be, for example, an automotive or other type of battery.

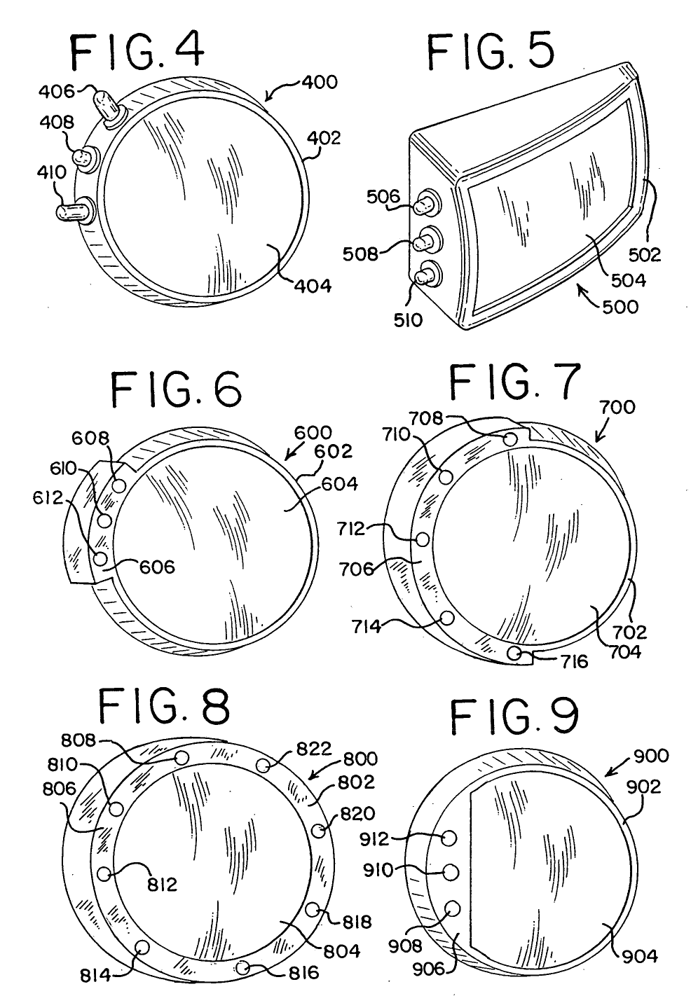

FIG. 4 is a perspective view of a combination indicator and blind spot mirror 400 with a rounded housing 402 having a mirror glass 404 secured to the housing 402. Three lights 406, 408, 410 extend from the housing 402, and they are of different sizes. The outside lights 406, 410 are larger than the inside light 408. Different-sized lights may be used in a variety of ways. For instance, the larger lights 406, 410 may be operative in relation to a particular automotive event, while the smaller light 408 is operative in relation to a different automotive event. Or, the larger lights 406, 410 may be alternately operative with the smaller light 408 in relation to a particular automotive event such that the larger lights 406, 410 may illuminate followed by the smaller light 408.

FIG. 5 is a perspective view of a combination indicator and blind spot mirror 500 with a rectangular housing 502. Similar to the above-mentioned embodiments, the combination indicator and blind spot mirror 500 features three lights 506, 508, 510. The combination indicator and blind spot mirror 500 also has a rectangular mirror glass 504 secured to the rectangular housing 502.

FIG. 6 discloses a combination indicator and blind spot mirror 600 with a housing 602 having a mirror glass 604 secured to the housing 602. The housing 602 includes a protective enclosure 606 that encloses three lights 608, 610, 612. The protective enclosure 606 may be made of any suitable material including, for example, clear plastic or opaque translucent plastic.

FIG. 7 illustrates a combination indicator and blind spot mirror 700 with a housing 702 having a mirror glass 704 secured to the housing 702. The housing 702 includes a protective enclosure 706. The protective enclosure 706 encloses five lights 708, 710, 712, 714, 716 arranged in a semicircle around the exterior of the housing 702.

FIG. 8 illustrates a combination indicator and blind spot mirror 800 with a housing 802 having a mirror glass 804 secured to the housing 802. A protective enclosure 806 encloses eight lights 808, 810, 812, 814, 816, 818, 820, 822 arranged in a circle around the exterior of the housing 802.

FIG. 9 illustrates a combination indicator and blind spot mirror 900 with a housing 902 having a mirror glass 904 secured to the housing 902. A protective enclosure 906 encloses three lights 908, 910, 912 arranged in the side of the housing 902.

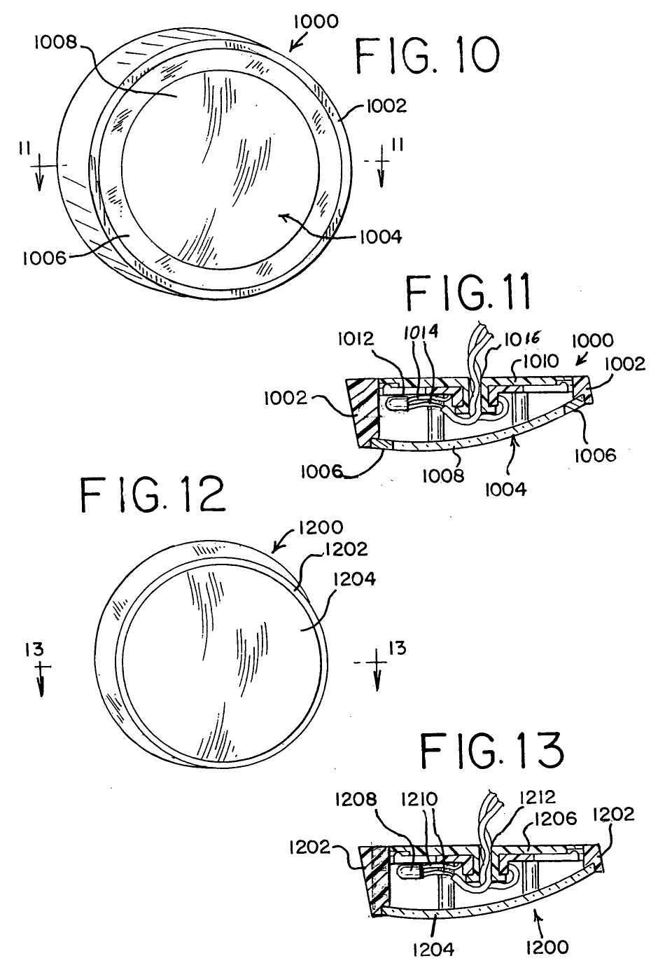

FIGS. 10 and 11 disclose a combination indicator and blind spot mirror 1000 with a housing 1002, a mirror glass 1004, and a base 1010. The mirror glass 1004 has a non-reflective portion 1006 adjacent to and coterminous with an edge of the mirror glass 1004 and a reflective portion 1008. The non-reflective portion 1006 allows light to pass through the mirror glass 1004 and may be formed in any way known in the art. Preferably, the non-reflective portion 1006 is located adjacent to the edge of the mirror glass 1004. In the embodiment shown, the non-reflective portion 1006 is also coterminous with the edge of the mirror glass 1004. In this exemplary embodiment, the non-reflective portion 1006 is a circular band surrounding the reflective portion 1008, though the non-reflective portion 1006 may be formed in any shape. Here, the non-reflective portion 1006 band has a width of less than one inch to allow for the reflective portion 1008 to be adequately sized for use in seeing blind spots, but this band may be of any width. Behind the mirror glass 1004 is at least one light 1012 whose emitted light shines through the non-reflective portion 1006 of the mirror glass 1004. The light 1012 may be located directly behind the non-reflective portion 1006, as shown, or anywhere inside the housing 1002 behind the mirror glass 1004. The light 1012 is connected to electrical wires 1014 that provide power to the light 1012. The wires 1014 extend through an aperture 1016 in the base 1010 and connect to a power source (not shown).

FIGS. 12 and 13 disclose a combination indicator and blind spot mirror 1200 with a housing 1202, a mirror glass 1204, and a base 1206. At least one light 1208 is connected to electrical wires 1210 that provide power to the light 1208. The wires 1210 extend through an aperture 1212 in the base 1204 and connect to a power source (not shown). At least a portion of housing 1202 is translucent to allow the portion of the housing 1202 to be illuminated when the light 1208 within the housing 1202 is operative. Further, though the portion of the housing 1202 which is translucent in this embodiment includes the entire housing 1202, the portion which is translucent may include only part of the housing 1202—e.g., a portion of the housing 1202 not including the base 1204 or some other desired portion of the housing 1202. The portion of the housing 1202 which is translucent may be of any color, as well—for example, the portion may be blue, red, white, or any other color. Or, the at least one light 1208 may illuminate different colors depending on the automotive event in relation to which the light is operative. For instance, when the combination indicator and blind spot mirror 1200 is intended for use as a parking light, the light 1208 may illuminate blue, red, or some other color in response to a parking light actuation. As a parking light, the light 1208 may remain operative for 24 hours or more, depending on the needs of the driver.

The combination indicator and blind spot mirror 1200 shown here is intended for use on a car side view mirror and is approximately two inches long at its longest axis. For car use, combination indicator and blind spot mirrors may be, for example, less than four inches long at their longest axes, for visibility purposes. An exemplary length for a combination indicator and blind spot mirror, at its longest axis, is two or three inches long.

It should be appreciated that the combination indicator and blind spot mirrors of the present invention are capable of being incorporated in the form of a variety of embodiments, only a few of which have been illustrated and described above. As well, many of the features described and claimed herein may be combined differently in various other embodiments, all of which are embraced to be within the scope of this specification. The invention may be embodied in other forms without departing from its spirit or essential characteristics, and the described embodiments are to be considered in all respects only as illustrative and not restrictive. All changes that come within the meaning and range of equivalency of the claims are embraced to be within their scope.

1. A combination indicator and blind spot mirror comprising:
a) a housing having a base capable of being secured to a mirror;
b) a mirror glass secured to the housing; and
c) at least one light, operative in relation to an automotive event, wherein at least a portion of the at least one light extends exterior of the housing.

2. The combination indicator and blind spot mirror of claim 1 wherein the at least one light comprises at least one light-emitting diode.

3. The combination indicator and blind spot mirror of claim 2 wherein the at least one light comprises two or three light-emitting diodes.

4. The combination indicator and blind spot mirror of claim 1 further comprising a protective enclosure enclosing the portion of the at least one light that extends exterior of the housing.

5. The combination indicator and blind spot mirror of claim 1 wherein the housing is rectangular.

6. The combination indicator and blind spot mirror of claim 1 wherein the housing is rounded.

7. The combination indicator and blind spot mirror of claim 6 wherein the at least one light comprises a plurality of lights arranged around the exterior of the rounded housing in a semicircle.

8. The combination indicator and blind spot mirror of claim 6 wherein the at least one light comprises at least three lights arranged around the exterior of the rounded housing in a circle.

9. The combination indicator and blind spot mirror of claim 1 wherein the at least one light comprises a plurality of lights of at least two different sizes.

10. The combination indicator and blind spot mirror of claim 1 wherein the at least one light comprises a plurality of lights of at least two different colors.

11. A combination indicator and blind spot mirror comprising:
a) a housing having a base capable of being secured to a mirror wherein at least a portion of the housing is translucent;
b) a mirror glass secured to the housing; and
c) at least one light, operative in relation to an automotive event, wherein the at least one light illuminates the translucent portion of the housing in relation to an automotive event.

12. The combination indicator and blind spot mirror of claim 11 wherein the at least one light comprises at least one light-emitting diode.

13. The combination indicator and blind spot mirror of claim 11 wherein the housing has a length less than four inches at its longest axis.

14. The combination indicator and blind spot mirror of claim 11 wherein the mirror glass is convex in relation to the base.

15. The combination indicator and blind spot mirror of claim 11 wherein the automotive event comprises one or both of a turn signal actuation and a hazard signal actuation.

16. The combination indicator and blind spot mirror of claim 11 wherein the automotive event comprises one or both of a reverse direction actuation and a brake actuation.

17. The combination indicator and blind spot mirror of claim 11 wherein the automotive event comprises one or both of a parking light actuation and a headlight actuation.

18. The combination indicator and blind spot mirror of claim 11 wherein the base is capable of being secured to an automotive side view mirror.

19. The combination indicator and blind spot mirror of claim 18 wherein the combination indicator and blind spot mirror is capable of aftermarket installation on the automotive side view mirror.

20. The combination indicator and blind spot mirror of claim 11 wherein the automotive event comprises one or more of a key accessory actuation, a locking mechanism actuation, and a door actuation.

21. The combination indicator and blind spot mirror of claim 11 wherein the combination indicator and blind spot mirror is capable of causing operation of the at least one light based on a wireless signal indicative of the automotive event.

22. The combination indicator and blind spot mirror of claim 11 wherein the base comprises a base attached to but separate from the remainder of the housing.

23. The combination indicator and blind spot mirror of claim 22 wherein the housing is rotatable with respect to the base.

24. A combination indicator and blind spot mirror comprising:
a) a housing having a base capable of being secured to a mirror;
b) a mirror glass secured to the housing, wherein a portion of the mirror glass is non-reflective and wherein the non-reflective portion of the mirror glass is adjacent to an edge of the mirror glass; and
c) at least one light, operative in relation to an automotive event, wherein light emitted from the at least one light shines through the non-reflective portion of the mirror glass in relation to the automotive event.

25. The combination indicator and blind spot mirror of claim 24 wherein the non-reflective portion of the mirror glass surrounds a portion of the mirror glass that is reflective.

26. The combination indicator and blind spot mirror of claim 25 wherein the non-reflective portion of the mirror glass comprises a band with a width of less than one inch.

27. The combination indicator and blind spot mirror of claim 24 wherein the at least one light comprises at least one light-emitting diode.

28. The combination indicator and blind spot mirror of claim 24 wherein the at least one light is selected from the group consisting of red lights, white lights, blue lights, and yellow lights.

29. The combination indicator and blind spot mirror of claim 24 wherein at least a portion of the non-reflective portion of the mirror glass is coterminous with the edge of the mirror glass.
